(19) United States
(12) Patent Application Publication
(10) Pub. No.: US 2018/0038585 A1
(43) Pub. Date: Feb. 8, 2018

(54) STEAM GENERATOR SYSTEM, CONTROL METHOD AND HOUSEHOLD APPLIANCE

(71) Applicant: MIDEA GROUP CO., LTD., Foshan (CN)

(72) Inventors: Hui ZHANG, Foshan (CN); Jizhe ZHANG, Foshan (CN); Lele MING, Foshan (CN); Chaolei ZHANG, Foshan (CN)

(21) Appl. No.: 15/307,671

(22) PCT Filed: May 31, 2016
(86) PCT No.: PCT/CN2016/084159

§ 371 Date: Oct. 28, 2016

(30) Foreign Application Priority Data
Dec. 14, 2015 (CN) 201510930620.X
Dec. 14, 2015 (CN) 201510931134.X
Dec. 14, 2015 (CN) 201521040340.3
Dec. 14, 2015 (CN) 201521040391.6

(51) Int. Cl. F22B 1/28; C02F 1/42; C02F 1/00; C02F 1/44; F22B 35/00; F22B 37/00

(52) U.S. Cl. CPC F22B 1/284; F22B 35/00; F22B 37/00; C02F 1/001; C02F 1/441; C02F 1/42; C02F 2303/22; C02F 2307/12; C02F 2103/02

(57) ABSTRACT

The present invention relates to a steam generator system (1000), a control method and a household appliance. The steam generator system (1000) comprises: a steam generator (100) comprising a housing (1) having a water inlet (13) and a steam outlet (14), and a heating element (3) provided in the housing (1); a water pump (300) connected between a water tank (200) and the water inlet (13); a water softener (400), wherein the water tank (200), the water pump (300) and the water inlet (13) are in communication with each other to form a water inlet pipeline, and the water softener (400) is connected to the water inlet pipeline in series.

### FIELD

The present disclosure relates to a technical field of household appliance, and more particularly to a steam generator system, a control method and a household appliance.

### BACKGROUND

An existing steam generator will be fully incrusted in a chamber after a period of time. Generally, the steam generator needs to be descaled artificially, which results in a cost increase. If the chamber of the steam generator is not descaled in time, a service life of the steam generator will be shortened, and even a security risk will be produced.

### SUMMARY

The present disclosure seeks to solve at least one of the problems existing in the related art to at least some extent. To this end, the present invention provides a steam generator system, which facilitates saving a cost and prolonging the service life of the steam generator.

The present invention further provides a control method for the steam generator.

The present invention further provides a household appliance including the above-described steam generator.

The steam generator system according to embodiments of the present invention, includes: a water tank; a steam generator comprising a housing having a water inlet and a steam outlet, and a heating element provided in the housing; a water pump connected between the water tank and the water inlet; and a water softener, in which the water tank, the water pump and the water inlet of the steam generator are in communication with each other to form a water inlet pipeline, and the water softener is connected to the water inlet pipeline in series.

In the steam generator system according to embodiments of the present invention, the water softener is connected to the water inlet pipeline in series to soften the water in the water inlet pipeline, and the water entering the steam generator is softened, such that during use of the steam generator, the scale in the steam generator can be significantly reduced, and the steam generator 100 does not need descaling, which saves the cost, prolongs the service life of the steam generator, and improves the use safety of the steam generator, so as to prolong the service life of the steam generator system.

According to some embodiments of the present invention, the water softener is provided in the water tank.

According to some embodiments of the present invention, V represents a flow rate of the water pump, and when the steam generator is in operation, the water pump continuously pumps water in the water tank into the housing at a flow rate of 20 ml/min≦V≦100 ml/min.

According to some embodiments of the present invention, the housing has a sealed chamber, a dividing wall is formed in the housing to divide the chamber into an outer chamber and an inner chamber spaced apart from each other, at least one communication groove is formed in the dividing wall to make the outer chamber in fluid communication with the inner chamber, the water inlet is in communication with the outer chamber, the steam outlet is in communication with the inner chamber, and the heating element is provided to the dividing wall to heat the inner chamber and the outer chamber; and the water pump pumps water in the water tank into outer chamber at a flow rate of 20 ml/min≦V≦100 ml/min.

Specifically, at least one flow passage is defined between the outer chamber and the inner chamber, a barrier wall is provided in the at least one flow passage to block the flow direction of a fluid, and the barrier wall is provided adjacent to the communication groove.

Specifically, the water inlet is located at a side of the barrier wall facing away from the communication groove.

Specifically, the steam generator further includes a first water inlet pipe in communication with the water inlet, and the first water inlet pipe has a water outlet end extending into the outer chamber.

Specifically, the water inlet and the communication groove are located at a same side of the barrier wall.

Specifically, the steam generator further includes a second water inlet pipe in communication with the water inlet, and the second water inlet pipe has a free end extending from a side of barrier wall adjacent to the communication groove to the other side of the barrier wall after encircling the dividing wall 2 in the circumferential direction.

Further, the second water inlet pipe has a plurality of first water outlet holes spaced apart.

Further, the free end of the second water inlet pipe is configured as a water outlet end.

Specifically, the steam generator further includes a third water inlet pipe in communication with the water inlet, and the third water inlet pipe has a water outlet end of extending into the side of the outer chamber facing away from the communication groove after penetrating the barrier wall.

Specifically, the steam generator further includes a fourth water inlet pipe in communication with the water inlet, the fourth water inlet pipe has a free end being closed, the fourth water inlet pipe passes through the barrier wall and extends in circumferential direction of the dividing wall, and a plurality of second water outlet holes are formed in a longitudinal direction of the fourth water inlet pipe and spaced apart.

Further, steam generated in the outer chamber forms steam cyclonic airflow after entering the inner chamber via the communication groove.

Further, an extending direction of the communication groove is tangent to an inner circumferential wall surface of the inner chamber, such that the steam generated in the outer chamber tangentially enters the inner chamber.

Specifically, the communication groove is formed in an upper portion of the dividing wall and is adjacent to a top wall of the housing.

Specifically, the heating element further includes an electrical terminal, and the electrical terminal is embedded in the barrier wall and exposed via a through hole in a side wall of the housing corresponding to the barrier wall.

Specifically, four end walls of the barrier wall are connected and integrally formed with the housing and the dividing wall respectively.

According to embodiments of the present invention, the housing includes a base, and a cover for sealing the base; the water inlet and the steam outlet are both provided in the cover.

Specifically, the heating element heats the inner chamber and the outer chamber simultaneously.

Specifically, the heating element is embedded in an interior of the dividing wall, an inner wall surface or an outer wall surface of the dividing wall.

Further, the steam generator further includes a pressure switch device, and the pressure switch device is provided at the steam outlet to make the steam in the base discharged unidirectionally via the steam outlet.

Further, a protruding post extends downward from the cover, a one-way passage with a passage opening at a bottom portion thereof is defined in the protruding post, an upper end of the one-way passage is in communication with the steam outlet, and the pressure switch device is provided in the one-way passage.

Further, the pressure switch device includes a seal element and an elastic element, and the seal element seals the passage opening under an elastic deformation force of the elastic element.

Further, the pressure switch device includes a one-way valve plate provided at the steam outlet.

Specifically, the steam generator further includes at least one scale containing structure, and the scale containing structure is provided in the inner chamber and/or the outer chamber.

Specifically, the scale containing structure is configured as at least one of a mesh grille, a strip grille and a columnar grille.

Specifically, the mesh grille and/or the strip grille are provided in the outer chamber, and two ends of the mesh grille and/or two ends of the strip grille are connected to an inner side wall of the outer chamber and an outer side wall of the dividing wall respectively.

Further, the inner side wall of the outer chamber is provided with a first snap groove, the outer side wall of the dividing wall is provided with a second snap groove, and the two ends of the mesh grille and/or the two ends of the strip grille snap into the first snap groove and the second snap groove respectively.

Specifically, the columnar grille is located in the outer chamber and/or the inner chamber, and includes a plurality of extending strips substantially extending in a substantial radial direction.

Further, the columnar grille includes a number of rounds of extending strips distributed in a height direction of the housing, and each round includes a plurality of extending strips distributed in a circumferential direction.

Further, the steam generator further includes at least one gain structure, and the gain structure is accommodated in the inner chamber and/or the outer chamber and is in contact with the dividing wall.

Further, the gain structure is provided on a top wall of the housing, and extends downward into the inner chamber and/or the outer chamber.

Further, the gain structure has a lower end spaced apart from a bottom wall of the housing.

Further, a plurality of gain structures is provided, and the plurality of gain structures is provided in a circumferential direction of the dividing wall.

The control method for the steam generator system according to embodiments of the present invention, in which the steam generator system is an above-described steam generator system, and the control method includes steps as follows:

S1: supplying power to the water pump and the heating element respectively;

S2: pumping the water in the water tank into the housing via the water inlet with the flow rate of 20 ml/min≦V≦100 ml/min by the water pump; and

S3: vaporizing the water pumped into the housing into steam by the heating element and discharging the steam via the steam outlet.

The control method of the steam generator system according to embodiments of the present invention may be used to control the steam generator system to improve the operating efficiency of the steam generator.

The household appliance according to embodiments of the present invention includes an above-described steam generator system.

The household appliance according to embodiments of the present invention can has a prolonged service life by being provided with the above-described steam generator system.

### BRIEF DESCRIPTION OF THE DRAWINGS

FIG. 1 is a schematic view of a steam generator according to some embodiments of the present invention;

FIG. 2 is a top view of the steam generator shown in FIG. 1;

FIG. 3 is a sectional view of the steam generator shown in FIG. 2 taken along line A-A;

FIG. 4 is a sectional view of the steam generator shown in FIG. 3 taken along line A-A, in which an elastic element and a seal element are removed from the steam generator;

FIG. 5 is a sectional view of the steam generator shown in FIG. 2 taken along line B-B;

FIG. 6 is an exploded schematic view of a steam generator according to other embodiments of the present invention;

FIG. 7 is a schematic view of a steam generator according to still other embodiments of the present invention;

FIG. 8 is a partial schematic view of the steam generator according to other embodiments of the present invention;

FIG. 9 is a top view of the steam generator shown in FIG. 7;

FIG. 10 is a sectional view of the steam generator shown in FIG. 9 taken along line C-C;

FIG. 11 is a partial schematic view of the steam generator shown in FIG. 7, in which a cover is removed from the steam generator;

FIG. 12 is a top view of the steam generator shown in FIG. 11;

FIG. 13 is a partial schematic view of the steam generator according to yet other embodiments of the present invention, in which a cover is removed from the steam generator;

FIG. 14 is a partial schematic view of the steam generator shown in FIG. 13, in which a scale containing structure is taken away;

FIG. 15 is a schematic view of a fluid flow direction in the steam generator shown in FIG. 13;

FIG. 16 is a top view of the steam generator according to other embodiments of the present invention;

FIG. 17 is a sectional view of the steam generator shown in FIG. 16 taken along line D-D;

FIG. 18 is a schematic view of the steam generator shown in FIG. 16, in which a cover is removed from the steam generator;

FIG. 19 is a schematic view of a connection of a steam generator system according to embodiments of the present invention.

### REFERENCE NUMERALS

1000: steam generator system;

100: steam generator;

1: housing; 11: outer chamber; 12: inner chamber; 13: water inlet; 14: steam outlet; 15: base; 16: cover; 162: rib; 161: protruding post; 1611: passage opening; 1612: one-way passage; 163: raised line; 2: dividing wall; 22: groove; 21: communication groove; 3: heating element; 31: electrical terminal; 4: pressure switch device; 41: seal element; 42: elastic element; 5: barrier wall; 51: first end wall; 52: second end wall; 53: third end wall; 54: fourth end wall; 55: seal groove; 61: first water inlet pipe; 62: second water inlet pipe; 621: first water outlet; 622: C-shaped pipe segment; 623: vertical pipe segment; 7: gain structure; 81: mesh grille; 82: strip grille; 83: columnar grille; 831: extending strip; 84: first snap groove; 85: second snap groove; 9: temperature controller; 10: fuse;

200: water tank; 300: water pump; 400: water softener.

### DETAILED DESCRIPTION

Description will be made in detail to embodiments of the present disclosure, and examples of the embodiments will be illustrated in drawings. The embodiments described herein with reference to drawings are explanatory, illustrative, and used to generally understand the present disclosure. The embodiments shall not be construed to limit the present disclosure.

In the specification of the present disclosure, it should be understood that the terms such as “central”, “lateral”, “length”, “upper”, “lower”, “vertical”, “horizontal”, “top”, “bottom”, “inner”, “outer”, “radial”, “circumferential”, etc. should be construed to refer to the orientation as then described or as shown in the drawings under discussion. These relative terms are for convenience and simplifying of description, and do not alone indicate or imply that the device or element referred to must have a particular orientation, or be constructed or operated in a particular orientation. Therefore, these relative terms should not be construed to limit the present disclosure.

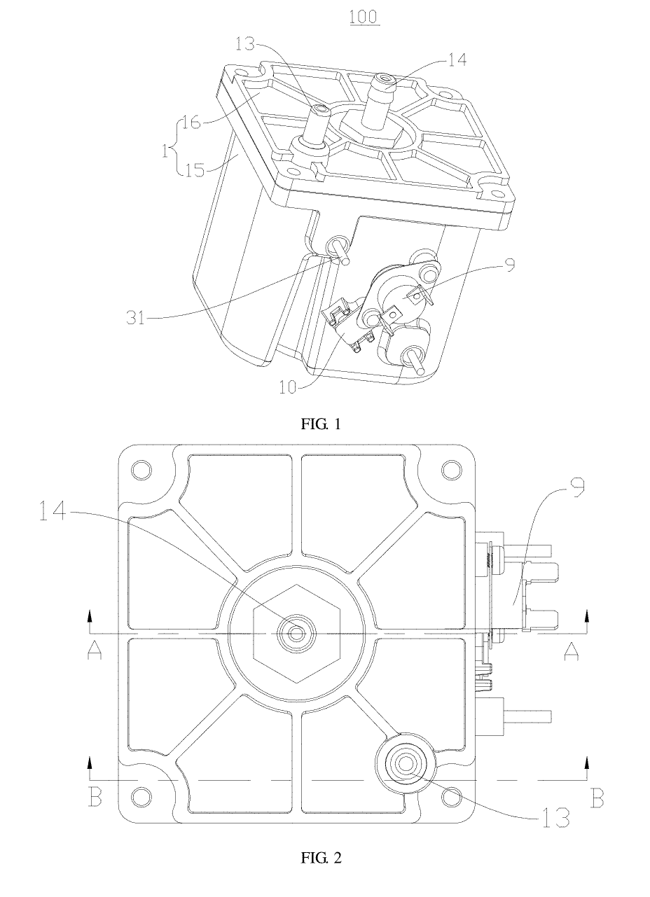

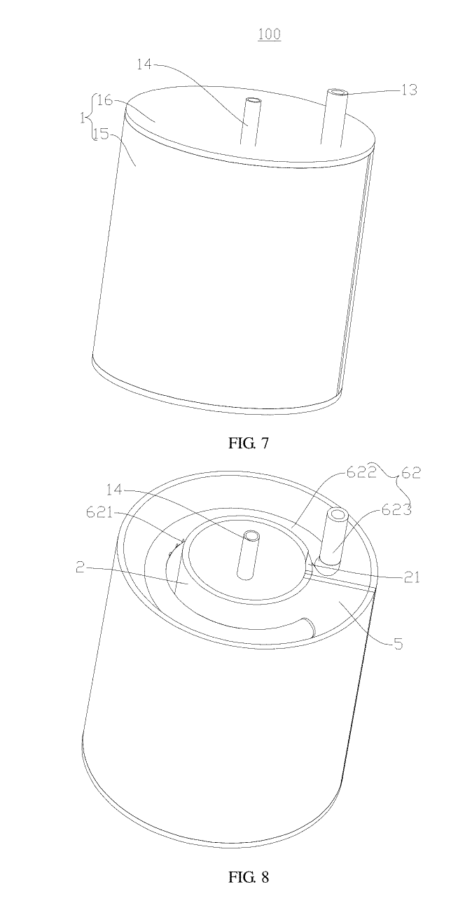

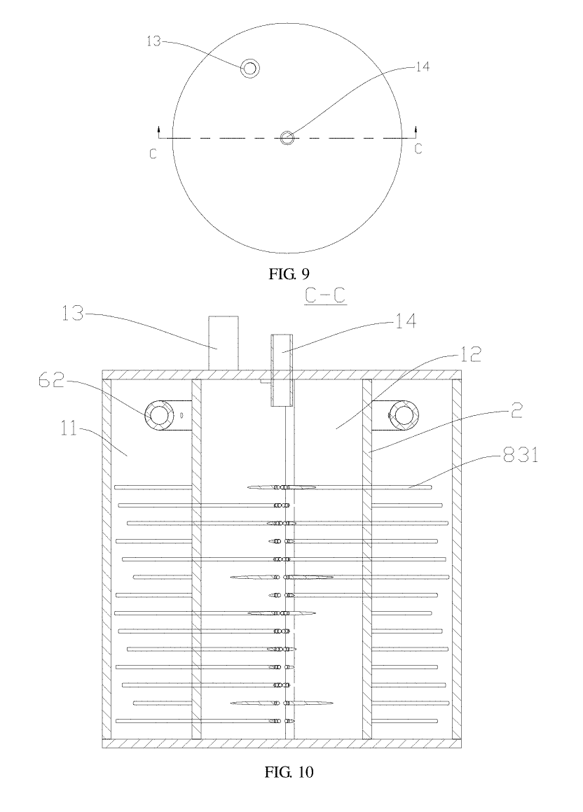

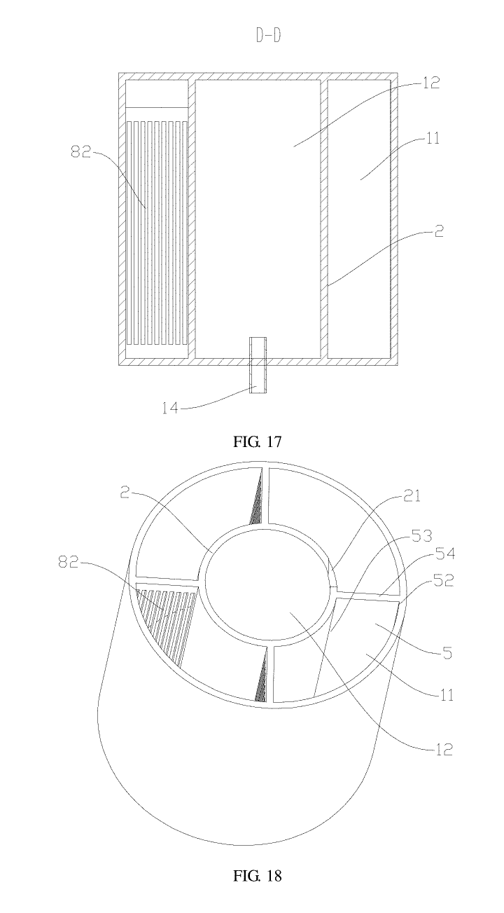

A steam generator system 1000 will be described below with reference to FIGS. 1 to 19. The steam generator system 1000 may be applied to a household appliance such as a vacuum cleaner, a garment steamer, a range hood, a coffee maker, a washing machine, an air conditioner or a microwave oven, etc., and used for generating steam.

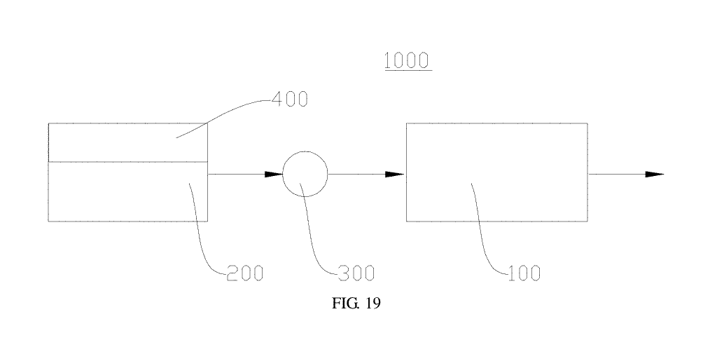

As shown in FIG. 19, the steam generator system according to embodiments of the present invention may include a steam generator 100, a water tank 200, a water pump 300 and a water softener 400. Optionally, the water pump 300 is configured as a displacement pump or a vane pump.

The steam generator 100 may include a housing 1 and a heating element 3. The heating element 3 may be provided in the housing 1, so as to conveniently heat the water in the housing 1.

The housing 1 is provided with a water inlet 13 and a steam outlet 14, so as to conveniently supply water into the housing 1 via the water inlet 13. The heating element 3 heats water in the housing 1 to vaporize the water into steam, and then the steam is discharged via the steam outlet 14.

Specifically, as shown in FIG. 19, the water pump 300 is connected between the water tank 200 and the water inlet 13. The water tank 200, the water pump 300 and the water inlet 13 of the steam generator 100 are in communication with each other to form a water inlet pipeline, so as to conveniently pump water into the steam generator 100.

The water softener 400 is connected to the water inlet pipeline in series. Therefore, the water softener 400 is connected to the water inlet pipeline in series to soften the water in the water inlet pipeline, and the water entering the steam generator 100 is softened. During use of the steam generator 100, scale in the steam generator 100 can be significantly reduced, and the steam generator 100 does not need descaling, which saves the cost, prolongs the service life of the steam generator 100, and improves safety of the steam generator 100 during use, so as to prolong the service life of the steam generator system 1000.

According to the steam generator system 1000 according to embodiments of the present invention, the water softener 400 is connected to the water inlet pipeline in series to soften the water in the water inlet pipeline, and water entering the steam generator 100 is softened. During use of the steam generator 100, scale in the steam generator 100 can be significantly reduced, and the steam generator 100 does not need descaling, which saves the cost, prolongs the service life of the steam generator 100, and improves safety of the steam generator 100 during use, so as to prolong the service life of the steam generator system 1000.

Optionally, as shown in FIG. 19, the water softener 400 is disposed in the water tank 200 to soften the water in the water tank 200. Of course, the present invention is not limited thereto. The water softener 400 may also be connected to other positions on the water inlet pipeline in series such as a position between the water pump 300 and the water inlet 13 of the steam generator 100. Optionally, the water softener 400 is configured as a softening resin or a reverse osmosis membrane, so as to improve a softening effect on the water in the water inlet pipeline and remove the scale in the water to a large extent.

In some embodiments of the present invention, when the steam generator 100 is in operation, the water pump 300 pumps the water in the water tank 200 into the housing 1 of the steam generator 100 continuously, and the heating element 3 heats continuously. Specifically, V represents a flow rate of the water pump 300, when the steam generator 100 is in operation, the water pump 300 continuously pumps the water in the water tank 200 into the housing 1 of the steam generator 100 at a flow rate of 20 ml/min≦V≦100 ml/min. Specifically, when the steam generator system 1000 is in operation, by making the water pump 300 continuously pump the water in the water tank 200 into the housing 1 of the steam generator 100 at a flow rate of 20 ml/min≦V≦100 ml/min, the water flowing into the housing 1 can be heated by the heating element 3, rapidly vaporized into steam and then discharged via the steam outlet 14. On the one hand, water can be conveniently added, and a pre-heat time of the steam generator 100 can be shortened, which ensures continuous discharge of the steam via the steam outlet 14, and improves the operating efficiency of the steam generator 100; on the other hand, a water level sensor and wiring, etc. does not need to be disposed in the steam generator 100, which makes for cost saving, facilitates assembling by workers, and meanwhile, improves the safety performance of the steam generator system 1000. It should be noted that, the water pump 300 continuously pumps the water in the water tank 200 into the housing 1 of the steam generator 100 at a flow rate of 20 ml/min≦V≦100 ml/min, said “continuously” may be construed as three embodiments including continuing without a stop, i.e. continuing without a break, continuing at equal time intervals, or continuing at unequal time intervals.

Optionally, P represents a power of the heating element 3, when 1000 W≦P≦2500 W, 20 ml/min≦V≦100 ml/min. Therefore, a degree of cooperation between the heating element 3 and the water pump 300 can be further optimized to avoid problems as followed: as the power of the heating element 3 is too low and the water pumped into the housing 1 by the water pump 300 is too much, the water in the housing 1 spills over; and as the power of the heating element 3 is too high and the water pumped into the housing 1 by the water pump 300 is too little, the heating element 3 has no water to heat but itself. Therefore, the safety of the steam generator system 1000 during use can be further improved.

Specifically, when the steam generator 100 is in operation, the water pump 300 continuously pumps the water in the water tank 200 into the housing 1, and the heating element 3 heats continuously. That is to say, once the steam generator 100 starts to operate, the water pump 300 continuously pump the water in the water tank 200 into the housing 1 without a break, and the heating element 3 continuously heat without a break. Of course, the present invention is not limited thereto. In other embodiments, when the steam generator system 1000 is in operation, the water pump 300 may pump a predetermined amount of water in the water tank 200 into the housing 1 at equal intervals or unequal intervals, the heating element 3 may heat continuously. For example, the water pump 300 may pump the predetermined amount of water into the housing 1 every 5 minutes, the heating element 3 heats continuously, even after the water pump 300 has pumped the predetermined amount of water into the housing 1 and stops pumping, the heating element 3 still heats. In which, it should be understood that, a time parameter that the water pump 300 pumps the water in the water tank 200 into the housing 1 at equal intervals or unequal intervals may be adaptively adjusted according to practical requirements.

According to some embodiments of the present invention, as shown in FIGS. 1 to 8, 10 to 15, 17 and 18, a sealed chamber is disposed in the housing 1, the heating element 3, etc. are disposed in the chamber. The heating element 3 includes an electrical terminal 31, and the electrical terminal 31 of the heating element 3 is exposed via a through hole formed in the housing 1.

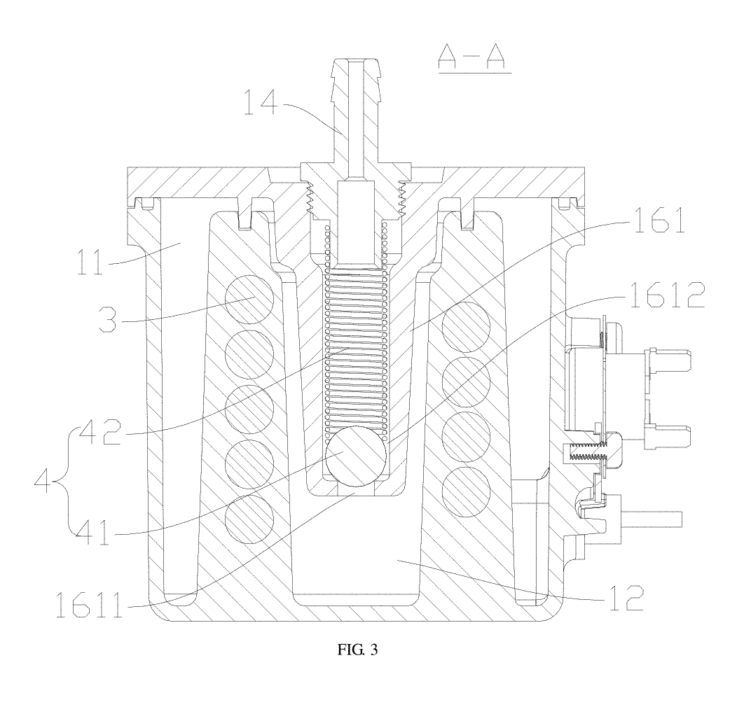

As shown in FIGS. 3, 4, 6, 8, 10 to 15, a dividing wall 2 is formed in the housing 1 to divide the chamber into an outer chamber 11 and an inner chamber 12 spaced apart from each other. For example, an annular dividing wall 2 is provided in the chamber of the housing 1 to define the outer chamber 11 and the inner chamber 12, and to make the outer chamber 11 surround the inner chamber 12. Thus, the dividing wall 2 provided in the housing 1 can makes for increase of an inner surface area of the housing 1, more scale can adhere, which can avoid decrease of energy efficiency even damage of the steam generator 100 resulting from the excessive scale to some extent, and prolong the service life of the steam generator 100.

The dividing wall 2 is provided with at least one communication groove 21 making the outer chamber 11 in fluid communication with the inner chamber 12. For example, one communication groove 21 is provided in the dividing wall 2 to facilitate fluid communication between the outer chamber 11 and the inner chamber 12. Of course, the present invention is not limited thereto. The dividing wall 2 may also be provided with a plurality of communication grooves 21, such as two, three, etc. to facilitate fluid communication between the outer chamber 11 and the inner chamber 12. Preferably, the dividing wall 2 is provided with one communication groove 21.

The housing 1 is provided with the water inlet 13 and the steam outlet 14, in which, the water inlet 13 is in communication with the outer chamber 11, and the steam outlet 14 is in communication with the inner chamber 12. Thus, by providing the inner chamber 12 and the outer chamber 11 spaced apart from each other in the housing 1, and meanwhile, making the water inlet 13 in direct communication with the outer chamber 11 and the steam outlet 14 in direct communication with the inner chamber 12, when the steam generator 100 is in operation, the water may be pumped into the outer chamber 11 by the water pump while the steam outlet 14 in communication with the inner chamber 12 continuously discharge the steam, thus solving the problem that water cannot conveniently added in an existing boiler type steam generator. Furthermore, compared with the existing boiler type steam generator having a large volume, the steam generator 100 of the present invention has a small volume, when the steam generator 100 is mounted in the household appliance together with the steam generator system 1000, the steam generator 100 can facilitate miniaturization of the household appliance. Optionally, the water inlet 13 may be provided at any position of a top wall of the housing 1 corresponding to the outer chamber 11.

The heating element 3 is provided in the dividing wall 2 to heat the inner chamber 12 and the outer chamber 11. Specifically, by providing the heating element 3 on the dividing wall 2, the thermal energy produced by the heating element 3 can be conducted rapidly to the fluid in the inner chamber 12 and the outer chamber 11 at first, a liquid fluid can be vaporized rapidly into a steam fluid after being heated to improve the utilization rate of electrical energy, and the heating element 3 can be prevented from overheating locally. For example, the heating element 3 may be embedded in an interior of the dividing wall 2, an inner wall surface or an outer wall surface of the dividing wall 2 to facilitate heating the inner chamber 12 and the outer chamber 11. Optionally, the heating element 3 may be integrally embedded in the interior of the dividing wall 2 based on a casting process, or fixedly provided on the inner wall surface or the outer wall surface of the dividing wall 2 to facilitate heating the inner chamber 12 and the outer chamber 11. Of course, the present invention is not limited thereto. The heating element 3 may also be provided at other positions of the housing 1, e. g. the heating element 3 is disposed in the inner chamber 12 or the outer chamber 11, or the heating element 3 is integrally embedded in any position of the housing 1 based on a casting process. It should be understood that, the dividing wall 2 provided in the housing 1 has a heat conducting effect.

Specifically, the water pump 300 pumps the water in the water tank 200 into the outer chamber 11 at a flow rate of 20 ml/min≦V≦100 ml/min, and the water entering the outer chamber 11 is heated by the heating element 3 and vaporized. When steam or a mixed fluid of water droplets and the steam in the outer chamber 11 enter the inner chamber 12 via the communication groove 21, the heating element 3 acts on the inner chamber 12 simultaneously, and the steam entering the inner chamber 12 is dried into a dry steam and then discharged via the steam outlet 14. Thus, by providing the heating element 3 in the dividing wall 2 to make the heating element 3 heat the inner chamber 12 and the outer chamber 11, and meanwhile by pumping the water into the outer chamber 11 through the water pump 300 to facilitate the continuously discharging of the steam via the steam outlet 14, it not only improves the utilization rate of the heating element 3, but also shortens the pre-heating time of the steam generator 100, which makes the steam generator 100 continuously generate steam with a high temperature and great dryness.

Specifically, as shown in FIGS. 1, 3, and 5 to 7, the housing 1 includes a base 15 and a cover 16 used for sealing the base 15. Specifically, the above-described chamber is provided in the base 15 and a top portion of the base 15 is open, the cover 16 closes the base 15 to seal the chamber. The dividing wall 2 is provided in the base 15 to define the outer chamber 11 and the inner chamber 12. In which, the water inlet 13 and the steam outlet 14 are both provided in the cover 16, which is not only simple in structure, but also facilitate arrangement of the heating element 3 and the dividing wall 2, etc. in the housing 1. Of course, the present invention is not limited thereto. The water inlet 13 and the steam outlet 14 may also be provided at other feasible positions, for example, the water inlet 13 and the steam outlet 14 are provided in the base 15, or provided in the base 15 and the cover 16 respectively, or others arrangement positions capable of achieving an equivalent above-described effect.

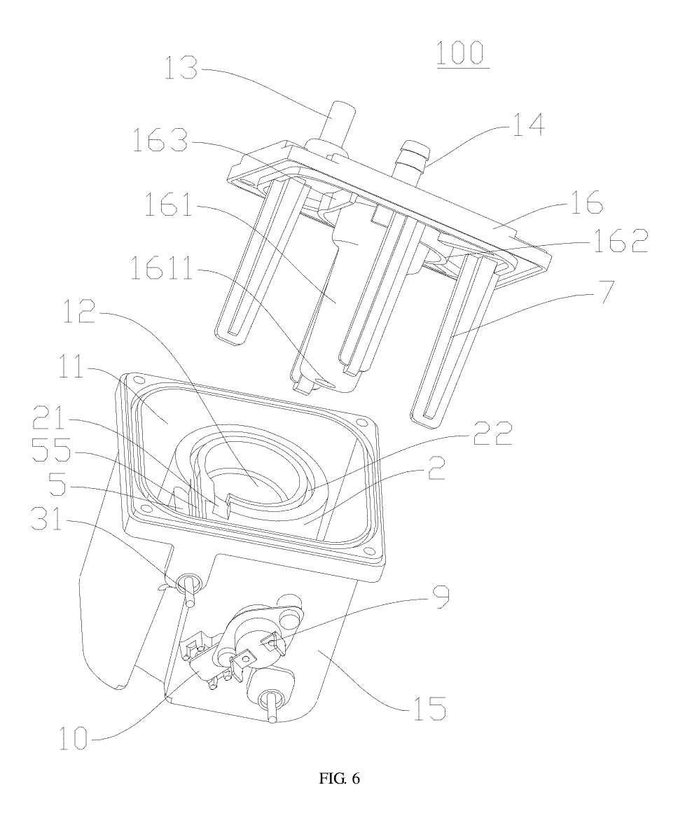

Optionally, the cover 16 is connected to the base 15 through a fastener such as a bolt in a sealing manner. Further optionally, as shown in FIG. 6, a bottom wall of the cover 16 is provided with a rib 162, and a top wall of the dividing wall 2 is provided with a substantially annular groove 22. When the cover 16 covers on the base 15, the rib 162 is fitted with the groove 22, meanwhile the cover 16 is further connected to the base 15 through the fastener, which further improves the sealing performance of the connection between the cover 16 and the base 15.

It should be understood that, the top wall of the housing 1 is the cover 16, a side wall of the housing 1 is a side wall of the base 15, a bottom wall of the housing 1 is a bottom wall of the base 15, the chamber of the housing 1 is the chamber of the base 15, and the chamber of the base 15 is sealed by the cover 16. Of course, in other embodiments, the cover 16 may also have a chamber, so that it is convenient for the chamber of the cover 16 to be assembled with the chamber of the base 15 in a sealing manner to define the chamber, that is, the housing 1 is formed by assembling an upper chamber and a lower chamber together in a sealing manner.

In some embodiments of the present invention, at least one flow passage is defined between the outer chamber 11 and the inner chamber 12, that is to say, at least one flow passage is provided outside the dividing wall 2 and located in the outer chamber 11. For example, the dividing wall 2 is annular, a plurality of flow passages are defined in the outer chamber 11 by a plurality of annular partition plates (not shown in the drawings), the plurality of flow passages are annular passages distributed in a radial direction of the dividing wall 2, and the plurality of flow passages are in communication with each other. For another example, one flow passage is provided between the outer chamber 11 and the inner chamber 12. It should be understood that, the one flow passage provided between the outer chamber 11 and the inner chamber 12 is a passage of the outer chamber 11.

A barrier wall 5 is provided in the at least one flow passage to block the flow direction of the fluid. That is to say, the barrier wall 5 is provided in the at least one flow passage to block the flow direction of the fluid such as the steam. For example, the plurality of flow passages are provided between the inner chamber 12 and outer chamber 11, and the barrier wall 5 is provided in one of the flow passages. For another example, as shown in FIGS. 6, 8, and 11 to 15, one flow passage is provided between the inner chamber 12 and the outer chamber 11, and the barrier wall 5 is provided between the inner chamber 12 and the outer chamber 11.

The barrier wall 5 is provided adjacent to the communication groove 21, so as to block the flow direction of the fluid.

Preferably, one flow passage is provided between the inner chamber 12 and the outer chamber 11, and the barrier wall 5 is provided in the outer chamber 11 and located outside of the dividing wall 2.

Further, the barrier wall 5 is provided in the outer chamber 11 to configure the outer chamber 11 as a C-shaped body. For example, when the housing 1 of the steam generator 100 is configured to be a substantial regular body such as a cube, a cylinder, a sphere or an ellipsoid, etc. the barrier wall 5 is provided in the outer chamber 11 to make the outer chamber 11 have a substantial C-shaped cross section. When the housing 1 of the steam generator 100 is designed as an irregular body, the barrier wall 5 is provided in the outer chamber 11 to make the outer chamber 11 have a substantial C-shaped cross section with equivalent effect.

Optionally, the barrier wall 5 may be integrally formed with the housing 1 and the dividing wall 2. Specifically, four end walls of the barrier wall 5 are connected to the housing 1 and the dividing wall 2 respectively and are provided in an integrally forming manner. For example, a portion of the side wall of the housing 1 is recessed into the outer chamber 11 inwards a center of the housing 1 to define the barrier wall 5. Of course, the present invention is not limited thereto. The barrier wall 5 and the housing 1 may also be two structures formed separately, for example, the barrier wall 5 is welded in the outer chamber 11.

Optionally, as shown in FIGS. 5 and 18, the barrier wall 5 includes a first end wall 51, a second end wall 52, a third end wall 53 and a fourth end wall 54. In which, the first end wall 51 is integrally connected to the bottom portion of the housing 1 (i.e. the bottom portion of the base 15), the second end wall 52 is integrally connected to the side wall of the housing 1 (i.e. the side wall of the base 15), the third end wall 53 is integrally connected to the outer side wall of the dividing wall 2, and the fourth end wall 54 is the top wall of the barrier wall 5. The fourth end wall 54 is provided with a seal groove 55 in communication with the above-described groove 22 of the top portion of the dividing wall 2, an inner top wall of the housing 1 (i.e. a bottom wall of the cover 16) is provided with a raised line 163 connected to the above-described rib 162. When the cover 16 covers the base 15, the rib 162 is fitted in the groove 22, and the raised line 163 is embedded in the seal groove 55, so as to make the barrier wall 5 block the flow direction of the fluid in the outer chamber 11 such as the steam.

Further, the electrical terminal 31 of the heating element 3 is embedded in the barrier wall 5 and exposed outside through the through hole in the side wall of the housing 1 corresponding to the barrier wall 5. Specifically, as the barrier wall 5 is integrally formed with the housing 1 and the dividing wall 2, the electrical terminal 31 of the heating element 3 provided in the dividing wall 2 is embedded in the barrier wall 5, and the side wall of the housing 1 corresponding to the barrier wall 5 is provided with the through hole, so that the electrical terminal 31 passes through the through hole and is exposed outside for electrical connection. Thus, the terminal of the heating element 3 is skillfully embedded in the barrier wall 5, which is simple in structure, and avoids a complicated arrangement of electric wires in the housing 1.

Optionally, the housing 1, and the dividing wall 2 and the barrier wall 5 formed in the housing 1 may all configured to be cast aluminum pieces.

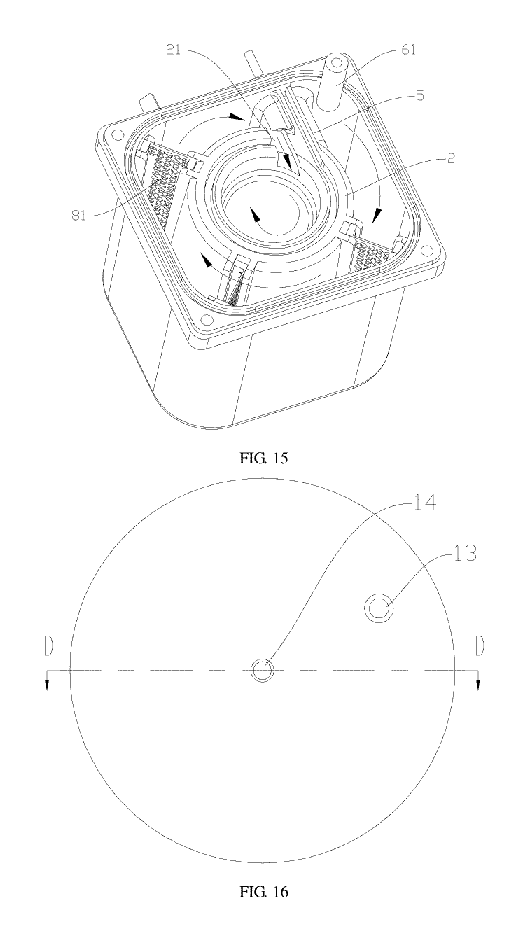

Further, the water inlet 13 is located at a side of the barrier wall 5 facing away from the communication groove 21, that is to say, the water inlet 13 and the communication groove 21 are located at two sides of the barrier wall 5 respectively. Thus, as shown in FIG. 15, the water flowing into the outer chamber 11 from the water inlet 13 is vaporized into the steam with low dryness under a heating effect of the heating element 3. Due to the effect of the barrier wall 5, the steam flows to the communication groove 21 after flowing along the outer chamber 11 and around a circle of the outer circumferential wall of the dividing wall 2, and enters the inner chamber 12 via the communication groove 21. The steam is heated and dried again after entering the inner chamber 12, and the steam is further converted into dry steam and discharged via the steam outlet 14. During the process, an area where the steam contacts with the inner and outer surfaces of the dividing wall 2 and the inner surface of the housing 1 is increased, and the heating element 3 provided in the dividing wall 2 can be prevented from overheating locally, which makes for prolonging the service life of the dividing wall 2 and the service life of the heating element 3, improves the heating efficiency of the heating element 3, and meanwhile, further shortens the pre-heating time of the steam generator 100 so as to improve the dryness of the steam.

Specifically, the steam generator 100 includes a first water inlet pipe 61 in communication with the water inlet 13, and a water outlet end of the first water inlet pipe 61 extends into the outer chamber 11. For example, as shown in FIG. 15, the water outlet end of the first water inlet pipe 61 extends downward into the outer chamber 11. Thus, the water outlet end of the first water inlet pipe 61 and the communication groove 21 are located at two sides of the barrier wall 5 respectively, the water outflowing from the water outlet end of the first water inlet pipe 61 flows in the outer chamber 11, and is converted into steam with low dryness after being heated by the heating element 3, and the steam needs to flow around a circle of the dividing wall 2 in order to enter the inner chamber 12 via the communication groove 21. During the process, an area where the steam contacts with the inner and outer surfaces of the dividing wall 2 and the inner surface of the housing 1 is increased, and the heating element 3 provided in the dividing wall 2 can be prevented from overheating locally, which makes for prolonging the service life of the dividing wall 2 and the service life of the heating element 3, improves the heating efficiency of the heating element 3, and meanwhile, further shortens the pre-heating time of the steam generator 100 so as to improve the dryness of the steam.

In other embodiments of the present invention, the water inlet 13 and the communication groove 21 are located at a same side of the barrier wall 5.

Specifically, as shown in FIGS. 8, 11 and 12, the steam generator 100 includes a second water inlet pipe 62 in communication with the water inlet 13, and a free end of the second water inlet pipe 62 extends from a side of the barrier wall 5 adjacent to the communication groove 21 to the other side of the barrier wall 5 after encircling the dividing wall 2 in the circumferential direction. Thus, after the water entering the outer chamber 11 from the second water inlet pipe 62 is converted into the steam under the heating effect of the heating element 3, at least a portion of the steam in the outer chamber 11 needs to flow around a circle of the dividing wall 2 in the circumferential direction in order to enter the inner chamber 12 via the communication groove 21. During the process, an area where the steam contacts with the inner and outer surfaces of the dividing wall 2 and the inner surface of the housing 1 is increased, and the heating element 3 provided in the dividing wall 2 can be prevented from overheating locally, which makes for prolonging the service life of the dividing wall 2 and the service life of the heating element 3, improves the heating efficiency of the heating element 3, and meanwhile, further shortens the pre-heating time of the steam generator 100 so as to improve the dryness of the steam.

Of course, the present invention is not limit thereto. The water inlet pipe may also be formed as other shapes, for example, a water inlet end of the water inlet pipe is in communication with the water inlet 13, and the other end of the water inlet pipe is provided around a plurality of turns of the dividing wall 2 in the circumferential direction. Or, the other end of the water inlet pipe may also be spirally wound around the dividing wall 2 in the circumferential direction.

Optionally, as shown in FIG. 8, the second water inlet pipe 62 is provided with a plurality of first water outlet holes 621 spaced apart. Thus, the water outflowing from the plurality of first water outlet holes 621 may be injected on the outer circumferential wall of the dividing wall 2, so that a water flow or water membrane is formed on the outer circumferential wall of the dividing wall 2, and flows downward along the outer circumferential wall of the dividing wall 2 to make the liquid water have a sufficient heat exchange with the heating element 3, furthermore, the steam generated from the water injected from the first water outlet holes 621 of the second water inlet pipe 62 facing away from the communication groove 21 needs to flow around a circle of the outer circumferential wall of the dividing wall 2 in order to enter the inner chamber 12 via the communication groove 21, thus improving the heating efficiency of the heating element 3, shortening the pre-heating time of the steam generator 100, and meanwhile, preventing the heating element 3 from overheating locally to prolong the service life of the heating element 3. Optionally, the plurality of first water outlet holes 621 are evenly spaced in a side of the second water inlet pipe 62 adjacent to the dividing wall 2, which is convenient for the water outflowing from the first water outlet holes 621 to be injected on the dividing wall 2 as much as possible to facilitate the heating of the heating element 3. It should be understood that, when the plurality of first water outlet holes 621 of the second water inlet pipe 62 are very small and inject atomized water droplets, the above-described advantage may be further optimized.

In other specific examples of the present invention, the free end of the second water inlet pipe 62 is configured as a water outlet end, thus, the water outlet end of the second water inlet pipe 62 is separated from the communication groove 21 by the barrier wall 5, the water outflowing from the water outlet end of the second water inlet pipe 62 is converted into the steam under the heating of the heating element 3, and the steam needs to flow around a circle of the outer circumferential wall of the dividing wall 2 in order to enter the inner chamber 12 via the communication groove 21. During the process, an area where the steam contacts with the inner and outer surfaces of the dividing wall 2 and the inner surface of the housing 1 is increased, and the heating element 3 provided in the dividing wall 2 can be prevented from overheating locally, which makes for prolonging the service life of the dividing wall 2 and the service life of the heating element 3, improves the heating efficiency of the heating element 3, and meanwhile, further shortens the pre-heating time of the steam generator 100 so as to improve the dryness of the steam.

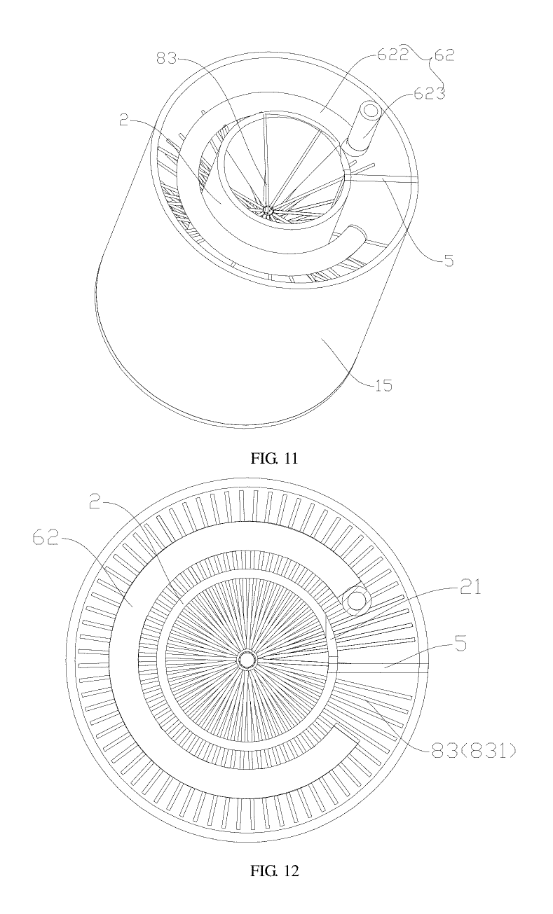

Specifically, as shown in FIGS. 8 and 11, the second water inlet pipe 62 includes a C-shaped pipe segment 622 and a vertical pipe segment 623 perpendicular to the C-shaped pipe segment 622 and connected to the water inlet 13, which is simple in structure. Further, the second water inlet pipe 62 surrounds the outer side of an upper outer wall surface of the dividing wall 2, thus, at least a portion of water discharged from the second water inlet pipe 62 may be injected on the outer side of the upper outer wall surface of the dividing wall 2, and flow downward along the dividing wall 2, so that the water can fully exchange heat with the heating element 3, which improves the heating efficiency of the heating element 3, and prevents the heating element 3 from overheating locally to some extent. Of course, the present invention is not limited thereto. The second water inlet pipe 62 may also surround other positions of the dividing wall 2 in a height direction, for example, the second water inlet pipe 62 surrounds the outer side of a middle outer wall surface or a lower outer wall surface of the dividing wall 2.

In other specific examples of the present invention, the steam generator 100 may also include a third water inlet pipe (not shown in the drawings) in communication with the water inlet 13, a water outlet end of the third water inlet pipe passes through the barrier wall 5 and extends into a side of the outer chamber 11 facing away from the communication groove 21, so as to make the water outlet end of the third water inlet pipe and the communication groove 21 located at two sides of the barrier wall 5 respectively, which is convenient for the water outflowing from the water outlet end of the third water inlet pipe to enter the outer chamber 11 and to be converted into the steam under the heating of the heating element 3, and at least a portion of the steam in the outer chamber 11 needs to flow around a circle of the dividing wall 2 in the circumferential direction in order to enter the inner chamber 12 via the communication groove 21. During the process, an area where the steam contacts with the inner and outer surfaces of the dividing wall 2 and the inner surface of the housing 1 is increased, and the heating element 3 provided in the dividing wall 2 can be prevented from overheating locally, which makes for prolonging the service life of the dividing wall 2 and the service life of the heating element 3, improves the heating efficiency of the heating element 3, and meanwhile, further shortens the pre-heating time of the steam generator 100 so as to improve the dryness of the steam.

Further, the steam generator 100 also includes a fourth water inlet pipe in communication with the water inlet 13 (not shown in the drawings), a free end of the fourth water inlet pipe is closed, meanwhile, the fourth water inlet pipe passes through the barrier wall 5 and extends in the circumferential direction of the dividing wall 2, and the fourth water inlet pipe is provided with a plurality of second water outlet holes (not shown in the drawings) spaced apart in a length direction thereof. Thus, the water outflowing from the plurality of second water outlet holes may be injected on the outer circumferential wall of the dividing wall 2, so that a water flow or water membrane is formed on the outer circumferential wall of the dividing wall 2, and flows downward along the outer circumferential wall of the dividing wall 2, which makes the liquid water have a sufficient heat exchange with the heating element 3, furthermore, the steam generated from the water injected from the second water outlet holes of the fourth water inlet pipe facing away from the communication groove 21 needs to flow around a circle of the outer circumferential wall of the dividing wall 2 in order to enter the inner chamber 12 via the communication groove 21, thus improving the heating efficiency of the heating element 3, shortening the pre-heating time of the steam generator 100, and meanwhile, preventing the heating element 3 from overheating locally to prolong the service life of the heating element 3. Optionally, the plurality of second water outlet holes are evenly spaced in a side of the fourth water inlet pipe adjacent to the dividing wall 2, which is convenient for the water outflowing from the second water outlet holes to be injected on the dividing wall 2 as much as possible. It should be understood that, when the plurality of second water outlet holes of the fourth water inlet pipe are very small and inject atomized water droplets, the above-described advantage may be further optimized.

According to some embodiments of the present invention, the steam formed in the outer chamber 11 forms a steam cyclonic airflow after entering the inner chamber 12 via the communication groove 21. Specifically, an extending direction of the communication groove 21 is tangent to an inner circumferential wall surface of the inner chamber 12, so that the steam formed in the outer chamber 11 tangentially enters the inner chamber 12 to form the steam cyclonic airflow.

Specifically, with the above-described configuration of the communication groove 21, under the heating of the heating element 3, the steam in the outer chamber 11 tangentially enters the inner chamber 12 via the communication groove 21, and forms the cyclonic airflow in the inner chamber 12 to make the steam contact with the inner wall surface of the inner chamber 12, meanwhile, the cyclonic airflow may form an effect of cyclone separator to make the liquid water of the steam thrown onto the inner wall of the inner chamber 12, vaporized rapidly or flow downward along the inner wall, and the liquid water further forms the steam under the heating of the heating element 3. Thus, on the one hand, the inner wall surface of the inner chamber 12 can be prevented from overheating locally to some extent to prolong the service life of the heating element 3, meanwhile, the heating efficiency of the heating element 3 can be improved, the pre-heating time of the steam generator 100 can be shortened, and the temperature and the dryness of the steam at the steam outlet 14 can be increased; on the other hand, the scale in the steam is thrown onto the inner wall surface of the inner chamber 12, and adheres to the inner wall surface of the inner chamber 12, which reduces the possibility for the scale to be discharged from the steam outlet 14, and avoids a harm resulting from that the steam outlet 14 is jammed by the scale.

Optionally, as shown in FIGS. 6, 8, and 11 to 15, the communication groove 21 is formed in the upper portion of the dividing wall 2 and is adjacent to the top wall (for example, adjacent to the cover 16) of the housing 1. Thus, the steam formed by water which is heated by the heating element 3 can conveniently move upward and enter the inner chamber 12 from the outer chamber 11.

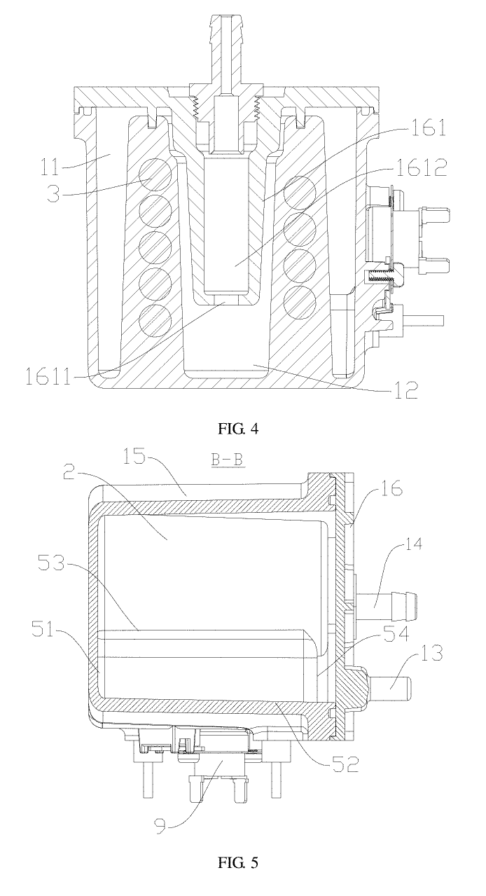

According to some further embodiments of the present invention, as shown in FIGS. 3 and 4, the steam generator 100 also includes a pressure switch device 4 provided at the steam outlet 14 to make the steam from the base 15 discharged unidirectionally via the steam outlet 14. The pressure switch device 4 provided at the steam outlet 14 may make the steam in the housing 1 discharged via the steam outlet 14 at a constant velocity and a high pressure. Specifically, when the heating element 3 is used for heating, the liquid water in the housing 1 is vaporized into the steam continuously. During the process, the pressure in the housing 1 increases continuously, when the pressure in the housing 1 is larger than a setting value, the pressure switch device 4 is opened, so that the dry steam is rapidly discharged via the steam outlet 14 at a high pressure. When the pressure in the housing 1 decreases to be equal to or less than the setting value, the pressure switch device 4 is closed and the pressure switch device 4 will not open until that the pressure in the housing 1 reaches up to the setting value again. Thus, the pressure switch device 4 provided at the steam outlet 14 can keep the housing 1 always has a certain pressure therein, which not only facilitates improving a saturation temperature of the steam in the housing 1 to raise the temperature and dryness of the steam at the steam outlet 14, but also facilitates improving the discharging velocity of the steam to ensure that the steam is discharged via the steam outlet 14 continuously and avoid continuous attenuation of the steam at the steam outlet 14. In which, it should be understood that, the setting value of the pressure in the housing 1 is related to a weight of the pressure switch device 4, accordingly, the setting value of the pressure in the housing 1 can be adjusted by adjusting the weight of the pressure switch device 4.

Further, as shown in FIGS. 3 and 4, a protruding post 161 extends downward from the cover 16, and a one-way passage 1612 having a passage opening 1611 is defined in the protruding post 161. An upper end of the one-way passage 1612 is in communication with the steam outlet 14, and the pressure switch device 4 is provided in the one-way passage 1612. Thus, a structure is simple, and the protruding post 161 extending downward from the cover 16 increases a surface area in the housing 1, so that the scale adheres to an outer surface of the protruding post 161, which avoids damage to the steam generator 100 resulting from the excessive scale to some extent, so as to prolong the service life of the steam generator 100. Of course, the present invention is not limited thereto. The cover 16 may not be provided with the protruding post 161.

Optionally, of the protruding post 161 has an annular cross section, and a cross sectional area of the protruding post 161 becomes smaller and smaller in a direction away from the cover 16.

In some further specific examples of the present invention, as shown in FIG. 3, the pressure switch device 4 includes a seal element 41 and an elastic element 42. In which, the seal element 41 seals the passage opening 1611 under an elastic deformation force of the elastic element 42. For example, the seal element 41 is located in the one-way passage 1612 and a lower end thereof seals the passage opening 1611, the elastic element 42 abuts between the steam outlet 14 and the seal element 41, so that the seal element 41 seals the passage opening 1611 according to the elastic deformation force of the elastic element 42. Thus, when the heating element 3 is heating, the pressure in the housing 1 increases continuously, and when the pressure in the housing 1 is larger than a setting value, the steam in the housing 1 pushes the seal element 41 upward to make the elastic element 42 in a compressed state, so that the steam passes through the passage opening 1611 and further passes through the one-way passage 1612 and finally is discharged via the steam outlet 14. When the pressure in the housing 1 is equal to or less than the setting value, the elastic element 42 abuts the seal element 41 against the passage opening 1611 to seal the passage opening 1611.

On the one hand, the above configuration can facilitate further improving a saturation temperature of the steam in the housing 1 to improve the temperature and dryness of the steam at the steam outlet 14, but also can facilitate improving the discharging velocity of the steam to ensure that the steam is discharged via the steam outlet 14 continuously and avoid continuous attenuation of the steam. On the other hand, the provided elastic element 42 and the seal element 41 can also block the scale and the liquid water of the steam in the housing 1, which not only avoids a pipe jam due to that the scale is discharged into a pipe connected to the steam outlet 14 along with the steam, but also further improves the dryness of the steam discharged via the steam outlet 14. In which, it should be understood that, the setting value of the pressure in the housing 1 is related to a weight of the elastic element 42 and the seal element 41, and an elastic coefficient and a deformation length of the elastic element 42. Accordingly, the setting value of the pressure in the housing 1 can be adjusted by adjusting the weight of the elastic element 42 and the seal element 41, and the elastic coefficient and the deformation length of the elastic element 42.

Optionally, the seal element 41 may be in the shape of a sphere, a cylinder, a cone or a cuboid, etc. Of course, it should be understood that, the seal element 41 may also be in the shape of other forms, as long as the passage opening 1611 can be closed and opened. Optionally, the seal element 41 may be configured as a piston, and the elastic element 42 may be configured as a spring.

Of course, the present invention is not limited thereto. In other embodiments of the present invention, the pressure switch device 4 includes a one-way valve plate provided at the steam outlet 14. For example, the pressure switch device 4 may be configured as the one-way valve plate to make the steam discharged unidirectionally via the steam outlet 14, which is simple in structure.

In some embodiments of the present invention, the heating element 3 may heat the inner chamber 12 and the outer chamber 11 simultaneously, that is to say, in the whole operation process of the heating element 3, the heating element 3 always heat the inner chamber 12 and the outer chamber 11 simultaneously. Of course, the present invention is not limited thereto. When the heating element 3 just starts to operate, the heating element 3 dose not heat the inner chamber 12 and the outer chamber 11 simultaneously, after a period of time, the heating element 3 heats the inner chamber 12 and the outer chamber 11 simultaneously. For example, during a period of time (for example, 5 seconds) when the heating element 3 just starts to operate, the heating element 3 first heats the outer chamber 11, so that the water in the outer chamber 11 is converted into the steam as soon as possible under the heating of the heating element 3 and enters the inner chamber 12. After a period of time (for example, 5 seconds), the heating element 3 heats the inner chamber 12 and the outer chamber 11 simultaneously, so that the heating element 3 continue to heat the water in the outer chamber 11 and the steam entering the inner chamber 12, so as to increase the dryness of the steam discharged via the steam outlet 14.

According to some embodiments of the present invention, as shown in FIG. 6, the steam generator 100 further includes at least one gain structure 7. The gain structure 7 is accommodated in the inner chamber 12 and/or the outer chamber 11, for example, the gain structure 7 may only be accommodated in the inner chamber 12, or may only be accommodated in the outer chamber 11, or there is a plurality of gain structures 7 and the plurality of gain structures 7 is accommodated in the inner chamber 12 and the outer chamber 11 respectively. Thus, by providing the gain structure 7 in the inner chamber 12 and/or the outer chamber 11, not only an internal surface area of the inner chamber 12 and/or the outer chamber 11 is increased, more scale can conveniently adhere to the gain structure 7, which prolongs the service life of steam generator 100 to some extent, but also the flowing of the scale along with the steam can be blocked to reduce the possibility that the scale flows out via the steam outlet 14.

The gain structure 7 is in contact with the dividing wall 2, thus transferring the heat generated by the heating element 3 to the gain structure 7 to facilitate the heat exchange between the gain structure 7 and the steam and/or the water flowing through the gain structure 7, and increasing the heat exchange area to improve the utilization rate of the heat from the heating element 3, reduce the operate time of the heating element 3 to some extent, and prolong the service life of the heating element 3, i.e. indirectly prolong the service life of the steam generator 100, meanwhile, the temperature and dryness of the steam can be increased.

Optionally, the gain structure 7 is not in contact with the inner side wall of the outer chamber 11 (i.e. the inner side wall of the housing 1/the inner side wall of the base 15), so as to avoid heat radiation to the exterior of the steam generator 100 to some extent due to a contact between the gain structure 7 and the inner side wall of the outer chamber 11. Of course, the present invention is not limited thereto. The gain structure 7 may be connected to the outer side wall of the dividing wall 2 and the inner side wall of the outer chamber 11 at the same time.

Further, the gain structure 7 is connected to the dividing wall 2, for example, the gain structure 7 and the dividing wall 2 are integrally formed in one piece, which is simple in structure. Of course, the present invention is not limited thereto. The gain structure 7 may also be provided on the top wall of the housing 1 (for example, the cover 16), and the gain structure 7 extends downward into the inner chamber 12 and/or the outer chamber 11 and is in contact with the dividing wall 2.

Specifically, a lower end of the gain structure 7 is spaced apart from the bottom wall of the housing 1 to facilitate the flowing of the water and the scale in the bottom portion of the housing 1 (the bottom portion of the cover 16), and to prevent the lower end of the gain structure 7 from being in contact with the bottom wall of the housing to avoid the accumulation of the scale therebetween. Optionally, the gain structure 7 has a substantially cross-shaped cross section, and a cross sectional area of the gain structure 7 gradually decreases in an up-and-down direction. Of course, the present invention is not limited thereto. The gain structure 7 may also in the shape of other forms, for example, a plate shape extending in the up-and-down direction.

Optionally, a plurality of gain structures 7 is provided, and the plurality of gain structures 7 is provided around the dividing wall 2 in the circumferential direction thereof. Specifically, the plurality of gain structures 7 is provided around the dividing wall 2 in the circumferential direction thereof and spaced apart. For example, there are four gain structures 7, the four gain structures 7 are accommodated in the outer chamber 11 and evenly spaced around the dividing wall 2 in the circumferential direction thereof. It should be understood that, sizes and shapes of the plurality of gain structures 7 may be the same, and may also be different.

According to some embodiments of the present invention, the steam generator 100 further includes at least one scale containing structure provided in the inner chamber 12 and/or the outer chamber 11. For example, the scale containing structure is only provided in the inner chamber 12, or only provided in the outer chamber 11, or a plurality of scale containing structures is provided in the outer chamber 11 and the inner chamber 12 respectively. Thus, by providing the scale containing structure, not only the internal surface area of the inner chamber 12 and/or the outer chamber 11 can be increased, more scale can conveniently adhere to the scale containing structure to prolong the service life of steam generator 100 to some extent, but also the flowing of the scale along with the steam can be blocked to reduce the possibility that the scale flows out via the steam outlet 14.

Further, referring to FIGS. 10 to 18, the scale containing structure is configured to be at least one of a mesh grille 81, a strip grille 82 and a columnar grille 83.

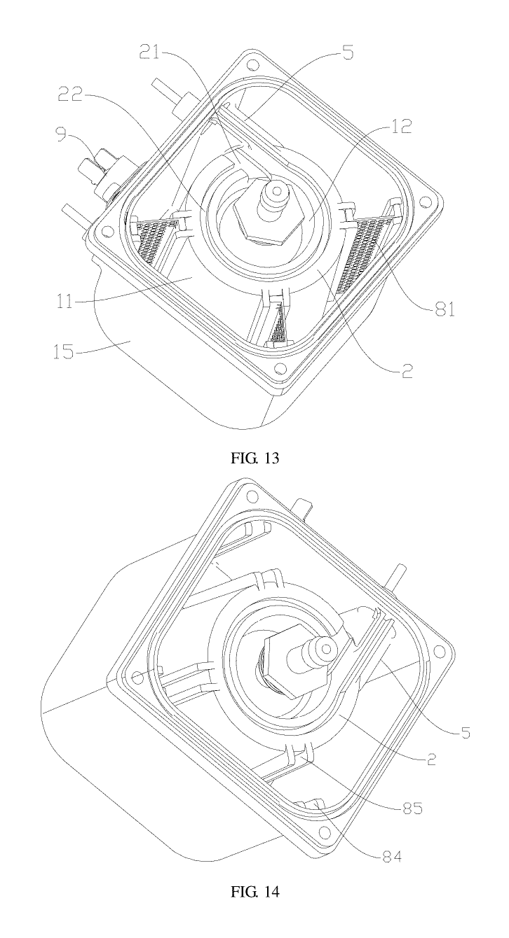

For example, as shown in FIGS. 13 and 15, the scale containing structure is configured as the mesh grille 81, thus facilitating increasing the internal the surface area of the housing 1 to facilitate adhering more scale to the mesh grille 81 to prolong the service life of steam generator 100 to some extent, and meshes of the mesh grille 81 may also block the flowing of the scale along with the steam to reduce the possibility that the scale flows out via the steam outlet 14. Meanwhile, because of the mesh grille 81, a filter screen does not need to be disposed at the steam outlet 14, so as to avoid problems in the art as followed: the steam outlet 14 is blocked because the scale adheres to the filter screen which is provided at the steam outlet 14, and a pipe is blocked because the scale on the filter screen flows into an external pipe in communication with the steam outlet 14 under the impact of the steam, and etc.

It should be noted that, a mesh of the mesh grille 81 may be formed as a circular hole, a hexagonal hole, or holes in other shapes, which is not limited by the present invention. It should be understood that, meshes in the mesh grille 81 may have the same size, of course, may also have different sizes. Optionally, sizes of the meshes in the mesh grille 81 are adjustable. For example, the sizes of the meshes in the mesh grille 81 may be adjusted according to different water qualities and operating conditions in different regions.

Optionally, there is a plurality of mesh grilles 81, and the plurality of mesh grilles 81 is spaced in the chamber where they are (i.e. the outer chamber 11 and/or the inner chamber 12). For example, as shown in FIGS. 13 and 15, three mesh grilles 81 are spaced in the outer chamber 11, so that an adhesion area for the scale increases to a greater extent, and the flowing of the scale along with the steam is blocked to a greater extent to decrease the possibility that the scale flows out via the steam outlet 14.

For example, as shown in FIGS. 17 and 18, the scale containing structure is configured as the strip grille 82, thus facilitating an increase in the internal surface area of the housing 1 to facilitate adhering more scale to the strip grille 82 to prolong the service life of steam generator 100 to some extent, and the flowing of the scale along with the steam can be blocked to reduce the possibility that the scale flows out via the steam outlet 14. Meanwhile, because of the strip grille 82, a filter screen does not need to be disposed at the steam outlet 14, so as to avoid problems in the art as followed: the steam outlet 14 is blocked because the scale adheres to the filter screen which is provided at the steam outlet 14, and the pipe is blocked because the scale on the filter screen flows into the external pipe in communication with the steam outlet 14 under the impact of the steam, and etc. In addition, since each grille hole of the strip grille 82 extends in a height direction of the strip grille 82, when the scale is blocked by the strip grille 82, the scale deposits downward to a bottom portion of the strip grille 82, which reduces the probability that the strip grille 82 is blocked by the scale, and ensures a flow area of the steam via the strip grille 82; and further when the steam is flowing through the strip grille 82, the flow rate of the steam is not excessively large to prevent the scale from rushing out via the steam outlet 14 together with the steam.

It should be understood that, sizes and the number of the grille holes of each strip grille 82 are adjustable, for example, the sizes of grille holes may be adjusted according to the different water qualities and operating conditions in different regions.

Optionally, there is a plurality of strip grilles 82, and the plurality of strip grilles 82 is spaced in the chamber where they are (i.e. the outer chamber 11 and/or the inner chamber 12). For example, as shown in FIG. 18, three strip grilles 82 are spaced in the outer chamber 11, so that an adhesion area for the scale increases to a greater extent, and the flowing of the scale along with the steam is blocked to a greater extent to decrease the possibility that the scale flows out via the steam outlet 14.

Further, the mesh grille 81 and/or the strip grille 82 are provided in the outer chamber 11, two ends of the mesh grille 81 and/or two ends of the strip grille 82 are connected to the inner side wall of the outer chamber 11 and the outer side wall of the dividing wall 2 respectively. For example, when the outer chamber 11 is only provided with the mesh grille 81 therein, two ends of the mesh grille 81 are connected to the inner side wall of the outer chamber 11 and the outer side wall of the dividing wall 2 respectively; when the outer chamber 11 is only provided with the strip grille 82 therein, two ends of the strip grille 82 are connected to the inner side wall of the outer chamber 11 and the outer side wall of the dividing wall 2 respectively; and when the outer chamber 11 is provided with the mesh grille 81 and the strip grille 82 therein simultaneously, two ends of the mesh grille 81 and two ends of the strip grille 82 are connected to the inner side wall of the outer chamber 11 and the outer side wall of the dividing wall 2 respectively. Thus, the steam flowing through the outer chamber 11 has to pass through the mesh grille 81 and/or the strip grille 82 in order to continue to flow forward, so that the flowing of the scale along with the steam is reliably blocked.

Specifically, referring to FIG. 14, the inner side wall of the outer chamber 11 is provided with a first snap groove 84, the outer side wall of the dividing wall 2 is provided with a second snap groove 85, and the two ends of the mesh grille 81 and/or two ends of the strip grille 82 are snapped into the first snap groove 84 and the second snap groove 85, thus reliably fixing the mesh grille 81 and/or the strip grille 82 in the outer chamber 11 to avoid a move or a waggle of the mesh grille 81 and/or the strip grille 82 in the outer chamber 11 due to an unstable fixation of the mesh grille 81 and/or strip grille 82, which affects a use effect of the mesh grille 81 and the strip grille 82.

For example, in a specific embodiment shown in FIG. 14, the first snap groove 84 and the second snap groove 85 both extend in a height direction of the housing 1 (i.e. a height direction of the base 15) to make the strip grille 82 and/or the mesh grille 81 reliably fixed between the outer chamber 11 and the dividing wall 2. Specifically, the first snap groove 84 is defined by two first protruding ribs protruding from the inner side wall of the outer chamber 11 and being spaced apart from each other. The second snap groove 85 is defined by two second protruding ribs protruding from the outer side wall of the dividing wall 2 and being spaced apart from each other, which is simple and reliable in structure. Optionally, the second protruding ribs and the dividing wall 2 may be integrally formed in one piece, and the first protruding ribs and the housing 1 may be integrally formed in one piece.

In further embodiments of the present invention, as shown in FIGS. 10 to 12, a columnar grille 83 is located in the outer chamber 11 and/or the inner chamber 12, and the columnar grille 83 includes a plurality of extending strips 831 substantially extending in a radial direction, thus facilitating an increase in the internal surface area of the outer chamber 11 and/or the inner chamber 12 to facilitate adhering more scale to the extending strips 831 to prolong the service life of the steam generator 100 to some extent. The extending strips 831 may also block the flowing of the scale along with the steam to some extent to reduce the possibility that the scale flows out via the steam outlet 14.

Specifically, the columnar grille 83 includes a number of rounds of extending strips 831 distributed in the height direction of the housing 1, each round includes a plurality of extending strips 831 distributed around a circumference (for example, around a circumference of the dividing wall 2), so as to increases the internal surface area of the outer chamber 11 and/or the inner chamber 12 to a greater extent to facilitate containing more scale, meanwhile, the flowing of the scale along with the steam can be blocked to a great extent to prolong the service life of the steam generator 100. Further, two adjacent rounds of extending strips 831 are staggered from each other in a height direction, for example, a number of rounds of extending strips 831 distributed in the height direction of the housing 1 (for example, the height direction of the base 15) are staggered from each other. Thus, when the scale flows along with the steam, the probability that the scale contacts with the extending strips 831 increases, the flowing of the scale along with the steam can be blocked, and further that the steam outlet 14 and the pipe connected to the steam outlet 14 are blocked by the scale outflowing along with the steam via the steam outlet 14 can be avoided, which prolongs the service life of the steam generator 100.

Optionally, the extending strips 831 extend from the outer side wall and/or the inner side wall of the dividing wall 2, for example, when the columnar grille 83 is provided in the inner chamber 12, the extending strips 831 extend from the inner side wall of the dividing wall 2 towards the inner chamber 12; when the columnar grille 83 is provided in the outer chamber 11, the extending strips 831 extend from the outer side wall of the dividing wall 2 towards the outer chamber 11; when the columnar grilles 83 are provided in the outer chamber 11 and the inner chamber 12 simultaneously, the plurality of extending strips 831 extend from the outer side wall of the dividing wall 2 towards the outer chamber 11 and extend from the inner side wall of the dividing wall 2 towards the inner chamber 12 respectively.

In some embodiments of the present invention, as shown in FIGS. 3 and 4, the heating element 3 is spirally around the dividing wall 2 in the circumferential direction thereof and is provided in the dividing wall 2. For example, there is one heating element 3 and the heating element 3 is spirally around the dividing wall 2 in the circumferential direction thereof and is provided in the dividing wall 2. So that a contact area of the heating element 3 and the dividing wall 2 increases to make the heating element 3 radiate more heat to the inner chamber 12 and the outer chamber 11 via the dividing wall 2, which shortens the pre-heat time of the steam generator 100 to improve the temperature and dryness of the steam. Of course, the present invention is not limited thereto. There may be a plurality of heating elements 3, and the plurality of heating elements 3 are distributed in an up-and-down direction of the dividing wall 2 and spaced apart from each other.

According to some embodiments of the present invention, the steam generator 100 further includes at least one temperature controller 9, and the temperature controller 9 controls the energization and de-energization of the heating element 3 according to a temperature of the housing 1.

As shown in FIGS. 1, 5 and 6, the temperature controller 9 is provided on an outer surface of the housing 1. For example, the temperature controller 9 is provided on an outer top wall of the housing 1 (i.e. an outer top wall of the cover 16), on an outer bottom wall of the housing 1 (i.e. an outer bottom wall of the base 15), or on an outer side wall of the housing 1 (i.e. an outer side wall of the base 15). Thus, providing the temperature controller 9 on the outer surface of the housing 1 not only facilitates the installation, maintenance and replacement of the temperature controller 9, but also optimizes an operating environment of the temperature controller 9. The temperature controller 9 does not needs to operate under a harsh environment, such that a range of choice of the temperature controller 9 is enlarged, for example, a temperature controller 9 with a low cost can be chosen, to facilitate decreasing a cost of the steam generator 100.

Optionally, in some examples, the temperature controller 9 is configured as an electronic temperature controller 9 which is connected with a first temperature sensor, the temperature controller 9 is provided on the outer surface of the housing 1 to make the first temperature sensor detect a temperature of the housing 1, and controls the energization and de-energization of the heating element 3 according to the temperature detected by the first temperature sensor. For example, when the first temperature sensor of the temperature controller 9 detects that the temperature of the housing 1 is greater than a predetermined maximum temperature, the temperature controller 9 controls the heating element 3 to stop heating; when the first temperature sensor detects that the temperature of the housing 1 is less than a predetermined minimum temperature, the temperature controller 9 controls the heating element 3 to heat, so as to ensure the use reliability of the heating element 3, improve the use safety of the steam generator 100, and prevents the steam generator 100 from burnout and other potential safety hazard, which results from an excessive high temperature due to continuous heating of the heating element 3.

Optionally, there is a plurality of temperature controllers 9, the plurality of temperature controller 9 are connected in parallel, and may be provided at different positions on the outer surface of the housing 1 respectively to detect temperatures of the different positions on the housing 1. For example, when a first temperature sensor of a first temperature controller 9 detects that a temperature of a position on the housing 1 where the first temperature controller 9 is located is greater than the predetermined maximum temperature value, the first temperature controller 9 can control the heating element 3 to stop heating. After the heating element 3 stops heating for a period of time, if a first temperature sensor of a second temperature controller 9 detects that a temperature of a position on the housing 1 where the second temperature controller 9 is located is less than the predetermined minimum temperature value, the second temperature controller 9 can control the heating element 3 to start to heat.

Of course, in other examples, the temperature controller 9 may be configured as a mechanical temperature controller 9 and is provided on the housing 1, and the temperature controller 9 may be disconnected or reset to control the energization and de-energization of the heating element 3.

In some embodiments of the present invention, as shown in FIGS. 1 and 6, the steam generator 100 further includes at least one fuse 10 provided on the outer surface of the housing 1. For example, the fuse 10 is provided on the outer top wall of the housing 1 (i.e. the outer top wall of the cover 16), on the outer bottom wall of the housing 1 (i.e. the outer bottom wall of the base 15), or on the outer side wall of the housing 1 (i.e. the outer side wall of the base 15), so as to facilitates the installation, maintenance and replacement of the fuse 10.

Each fuse 10 includes a second temperature sensor, and the fuse 10 is provided on the outer surface of the housing 1 to make the second temperature sensor detect the temperature of the housing 1. When the second temperature sensor detects that the temperature of the housing 1 is greater than a predetermined value, the fuse 10 controls the heating element 3 to be de-energized. Specifically, when the second temperature sensor of the fuse 10 detects that the temperature of the housing 1 is unusually high (for example, when the steam generator 100 is in abnormal operation and the temperature controller 9 breaks down) and is greater than the predetermined value, the fuse 10 can blow to make the heating element 3 de-energized, so as to stop the heating element 3 from heating, which improves the use safety of the steam generator 100.

Optionally, there may be a plurality of fuses 10, the plurality of fuses 10 are connected in parallel, and may be provided on different positions on the outer surface of the housing 1.

Further, the temperature controller 9 is provided on the outer side wall of the housing 1, for example, the temperature controller 9 is provided on the outer side wall of the base 15. Optionally, the fuse 10 and the temperature controller 9 both are provided on the outer side wall of the base 15.

In some embodiments of the present invention, as shown in FIGS. 1 to 18, the housing 1 is configured as a cube, a sphere, an ellipsoid or a cylinder generally, which is simple in structure. Optionally, the dividing wall 2 is formed to be a circular annular or square annular shape, that is, the dividing wall 2 has a circular annular or square annular cross section to divide the outer chamber 11 and the inner chamber 12. Of course, the present invention is not limited thereto. The dividing wall 2 may have a cross section of other shapes, such as an elliptical cross section.

Optionally, the steam outlet 14 is provided in a position corresponding to a center of the inner chamber 12. Of course, the present invention is not limited thereto. The steam outlet 14 may also be provided in other positions on the top wall of the housing 1 (i.e. the cover 16) corresponding to the inner chamber 12, as long as it is convenient for the steam in the inner chamber 12 to be discharged.

Optionally, a central line of the dividing wall 2 and a central line of the housing 1 are collinear, that is to say, a central line of the inner chamber 12 and a central line of the outer chamber 11 are collinear. Thus, it is convenient for the steam to flow through the outer chamber 11 smoothly, and it is convenient for the heating element 3 to heat the steam in the outer chamber 11 uniformly. Of course, it should be understood that the central line of the inner chamber 12 and the central line of the outer chamber 11 may also not be collinear.

A control method for the steam generator system according to the embodiments of the present invention will be described below. In which, the steam generator system is the above-described steam generator system, and the control method for the steam generator system includes at least steps as follows.

S1: Power is supplied to the water pump and the heating element. For example, when the steam generator system is applied to the household appliance, the water pump and the steam generator are energized by connecting a power plug of the household appliance to a live socket, it should be understood that after the steam generator is energized, the heating element is energized.

S2: The water pump pumps the water in the water tank into the housing via the water inlet at the flow rate of 20 ml/min≦V≦100 ml/min. For example, the water pump pumps the water in the water tank via the water inlet into the outer chamber in communication with the water inlet at the flow rate of 20 ml/min≦V≦100 ml/min.

S3: The heating element vaporizes the water pumped into the housing into the steam to be discharged via the steam outlet. For example, the heating element heats the water pumped into the outer chamber to vaporize the water into the steam; and the steam enters the inner chamber via the communication groove, and forms the dry steam under the further heating of heating element in the inner chamber to be discharged via the steam outlet.

The control method for the steam generator system according to embodiments of the present invention makes for improvement of the operating efficiency of the steam generator.

The household appliance according to embodiments of the present invention includes an above-described steam generator system 1000.

The household appliance according to embodiments of the present invention can have a prolonged service life, by providing the above-described steam generator system 1000.

According to some embodiments of the present invention, the household appliance may be a vacuum cleaner, a garment steamer, a range hood, a coffee maker, a washing machine, an air conditioner or a microwave oven.

In the present invention, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications or interactions of two elements, which can be understood by those skilled in the art according to specific situations.

Reference throughout this specification to “an embodiment,” “some embodiments,” “an example,” “a specific example,” or “some examples,” device that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples. In addition, those skilled in the art can combine the different embodiments or examples and the features of the different embodiments or examples described in this specification without conflicting situations.

Although explanatory embodiments have been shown and described, it would be appreciated that the above embodiments cannot be construed to limit the present disclosure, and changes, alternatives, and modifications can be made in the embodiments within the scope of the present disclosure by those skilled in the art.

1. A steam generator system, comprising:
a water tank;
a steam generator comprising a housing having a water inlet and a steam outlet, and a heating element provided in the housing;
a water pump connected between the water tank and the water inlet; and
a water softener, wherein the water tank, the water pump and the water inlet of the steam generator are in communication with each other to form a water inlet pipeline, and the water softener is connected to the water inlet pipeline in series.

2. (canceled)

3. The steam generator system according to claim 1, wherein V represents a flow rate of the water pump, and when the steam generator is in operation, the water pump continuously pumps water in the water tank into the housing at a flow rate of 20 ml/min≦V≦100 ml/min.

4. The steam generator system according to claim 3, wherein the housing has a sealed chamber, a dividing wall is formed in the housing to divide the chamber into an outer chamber and an inner chamber spaced apart from each other, at least one communication groove is formed in the dividing wall to make the outer chamber in fluid communication with the inner chamber, the water inlet is in communication with the outer chamber, the steam outlet is in communication with the inner chamber, and the heating element is provided to the dividing wall to heat the inner chamber and the outer chamber;
and the water pump pumps water in the water tank into outer chamber at a flow rate of 20 ml/min≦V≦100 ml/min.

5. The steam generator system according to claim 4, wherein at least one flow passage is defined between the outer chamber and the inner chamber, a barrier wall is provided in the at least one flow passage to reduce a flow velocity of a fluid, and the barrier wall is provided adjacent to the communication groove.

6. The steam generator system according to claim 5, wherein the water inlet is located at a side of the barrier wall facing away from the communication groove.

7. The steam generator system according to claim 6, wherein the steam generator further comprises a first water inlet pipe in communication with the water inlet, and the first water inlet pipe has a water outlet end extending into the outer chamber.

8. The steam generator system according to claim 5, wherein the water inlet and the communication groove are located at a same side of the barrier wall.

9. The steam generator system according to claim 8, wherein the steam generator further comprises a second water inlet pipe in communication with the water inlet, the second water inlet pipe has a free end extending from a side of barrier wall adjacent to the communication groove to the other side of the barrier wall after encircling the dividing wall 2 in the circumferential direction.

10. (canceled)

11. (canceled)

12. The steam generator system according to claim 8, wherein the steam generator further comprises a third water inlet pipe in communication with the water inlet, and the third water inlet pipe has a water outlet end extending into a side of the outer chamber facing away from the communication groove after penetrating the barrier wall.

13. The steam generator system according to claim 8, wherein the steam generator further comprises a fourth water inlet pipe in communication with the water inlet, the fourth water inlet pipe has a free end being closed, the fourth water inlet pipe passes through the barrier wall and extends in a circumferential direction of the dividing wall, and a plurality of second water outlet holes are formed in a longitudinal direction of the fourth water inlet pipe and spaced apart.

14. (canceled)

15. The steam generator system according to claim 4, wherein an extending direction of the communication groove is tangent to an inner circumferential wall surface of the inner chamber, such that the steam generated in the outer chamber tangentially enters the inner chamber.

16. (canceled)

17. (canceled)

18. (canceled)

19. The steam generator system according to claim 1, wherein the housing comprises a base and a cover for sealing the base, wherein the water inlet and the steam outlet are both provided in the cover.

20. (canceled)

21. (canceled)

22. The steam generator system according to claim 19, wherein the steam generator further comprises a pressure switch device, and the pressure switch device is provided at the steam outlet to make the steam in the base discharged unidirectionally via the steam outlet.

23. The steam generator system according to claim 22, wherein a protruding post extends downward from the cover, a one-way passage having a passage opening in a bottom portion thereof is defined in the protruding post, an upper end of the one-way passage is in communication with the steam outlet, and the pressure switch device is provided in the one-way passage.

24. The steam generator system according to claim 23, wherein the pressure switch device comprises a seal element and an elastic element, and the seal element seals the passage opening under an elastic deformation force of the elastic element.

25. The steam generator system according to claim 22, wherein the pressure switch device comprises a one-way valve plate provided at the steam outlet.

26. The steam generator system according to claim 4, wherein the steam generator further comprises at least one scale containing structure, and the scale containing structure is provided in the inner chamber and/or the outer chamber.

27. The steam generator system according to claim 26, wherein the scale containing structure is configured as at least one of a mesh grille, a strip grille and a columnar grille.

28. The steam generator system according to claim 27, wherein the mesh grille and/or the strip grille are provided in the outer chamber, and two ends of the mesh grille and/or two ends of the strip grille are connected to an inner side wall of the outer chamber and an outer side wall of the dividing wall respectively.

29. (canceled)

30. The steam generator system according to claim 27, wherein the columnar grille is located in the outer chamber and/or the inner chamber, and comprises a plurality of extending strips substantially extending in a radial direction.

31. (canceled)

32. The steam generator system according to claim 4, wherein the steam generator further comprises at least one gain structure, and the gain structure is accommodated in the inner chamber and/or the outer chamber and is in contact with the dividing wall.

33. The steam generator system according to claim 32, wherein the gain structure is provided on a top wall of the housing, and extends downward into the inner chamber and/or the outer chamber.

34. (canceled)

35. (canceled)

36. A control method for a steam generator system, wherein the steam generator system is a steam generator system according to claim 3, and the control method comprises steps as follows:
S1: supplying power to the water pump and the heating element;
S2: pumping the water in the water tank into the housing via the water inlet at the flow rate of 20 ml/min≦V≦100 ml/min by the water pump; and
S3: vaporizing the water pumped into the housing into steam by the heating element and discharging the steam via the steam outlet.

37. A household appliance, comprising a steam generator system according to claim 1.
